(19) United States
(12) Patent Application Publication
(10) Pub. No.: US 2003/0027461 A1
(43) Pub. Date: Feb. 6, 2003

(54) Connector assembly

(76) Inventor: Kent Kuo, Taipei (TW)

Correspondence Address: BACON & THOMAS, PLLC, 625 SLATERS LANE, FOURTH FLOOR, ALEXANDRIA, VA, 22314

(21) Appl. No.: 09/917,616

(22) Filed: Jul. 31, 2001

(51) Int. Cl. H01R 13/502; H01R 13/514

(52) U.S. Cl. 439/701

(57) ABSTRACT

A connector assembly allows the contact surfaces of the contact legs making front face contact with each other when the matching contact legs are coupled to make contact. The contact legs are formed in a continuous undulatory shape by directly punching a base plate. The contact legs are wedged in leg troughs of the connector through the base plate. The resulting connector has more stable and secure contact between the contact legs.

### BACKGROUND OF THE INVENTION

The present invention relates to a connector assembly and particularly a connector that forms front face contact between the corresponding contact legs when the matching connectors are coupled thereby to achieve stable and secure connections between the contact legs.

The connectors now available on the market generally are constructed by inserting the contact legs individually in the slots of the connector.

The contact between the contact legs of conventional connectors is generally done by frictional approach. During inserting the contact legs, the electroplated layer on the contact legs are easy to wear out or even peel off under the abrasive movements and could result in not proper signal transmission.

Moreover, although there are various types of connectors on the market, they are mostly formed by directly coupling two casings. One casing has a tenon and another casing has an groove to form a matched coupling.

The conventional connectors set forth above generally include a plurality of contact legs which have specific signal transmission function. Once there is a contact error happened on the contact legs, it could cause short circuit. As conventional connectors mostly adopt frictional contact, the plated layer on the contact legs is easy to wear off or peel off and result in not proper signal transmission and shorter service life of the contact legs.

Furthermore, assembly of the contact legs in the conventional connector is not reliable and is prone to cause dislocation. As a result, two ends of the contact legs could be not aligned properly. Additional trimming processes have to be done to fix this problem. It could even cause the contact legs breaking away from the connectors.

### SUMMARY OF THE INVENTION

The primary object of the invention is to resolve the foregoing disadvantages. The invention aims to provide a connector assembly that offers front face contact between the corresponding contact legs during fastening. Moreover, a clipping structure is provided on the leg troughs to allow the matching contact legs having more stable and secure contact with each other. There is also a fool proof feature to couple two casings only in one direction.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a front view of a casing of the invention.

FIG. 3 is a top view of a casing of the invention.

FIG. 4 is a perspective view of the invention after assembled.

FIG. 5 is a fragmentary enlarged perspective view according to FIG. 4.

FIG. 6 is an exploded view of an embodiment of the invention.

### DESCRIPTION OF THE PREFERRED EMBODIMENT

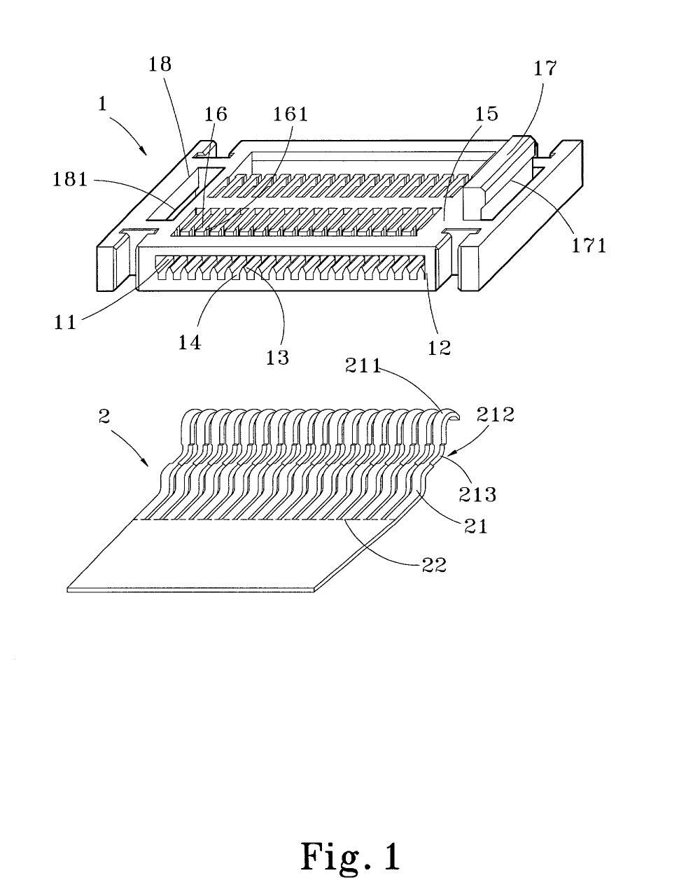

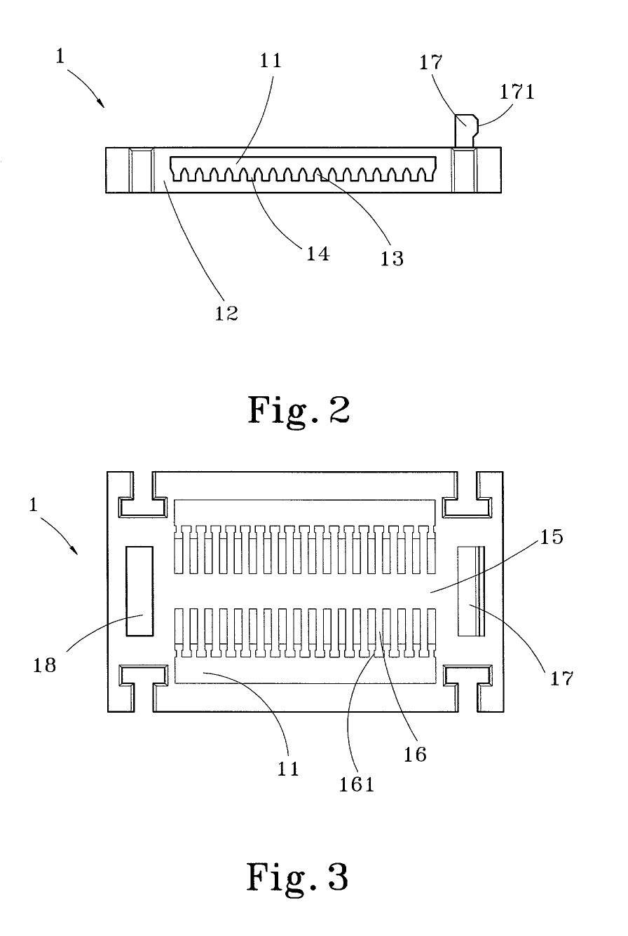

Referring to FIGS. 1, 2, and 3, the invention includes a base plate 2 formed with a plurality of contact legs 21 and a connector casing 1 which has a plurality of leg troughs 14. The base plate 2 is inserted into the casing 1 to wedge the contact legs 21 into the leg troughs 14. Then the base plate 2 is cut off at a slitting line 22 to allow the connector casing 1 embedded with a plurality of independent contact legs 21.

The casing 1 has a housing chamber 11 which has a front side 12 formed with a plurality of leg troughs 14 spaced by first separators 13. There is a contact end surface 15 above the housing chamber 11. On the contact end surface 15 there are second separators 16 matching the number of the first separators 13. Each second separator 16 has two bulged clip sections 161 formed on two lateral sides at one end thereof. At one side of the contact end surface 15, there is a snap hook 17 extending upwards at a selected location. The latch hook 17 has a latch lug 171 formed on one side thereof. At another side of the contact end surface 15, there is a latch groove 18 which has a stepwise latch notch 181 formed therein.

The casing 1 may be made of plastics by integral injection forming. The snap hook 17 may also be made separately (not shown in the drawings).

The contact legs 21 are formed a continuous undulatory shape by punching the base plate 2. Each contact leg 21 has a snap section 212 which in turn has a slot 213 matching and engageable with the clip section 161.

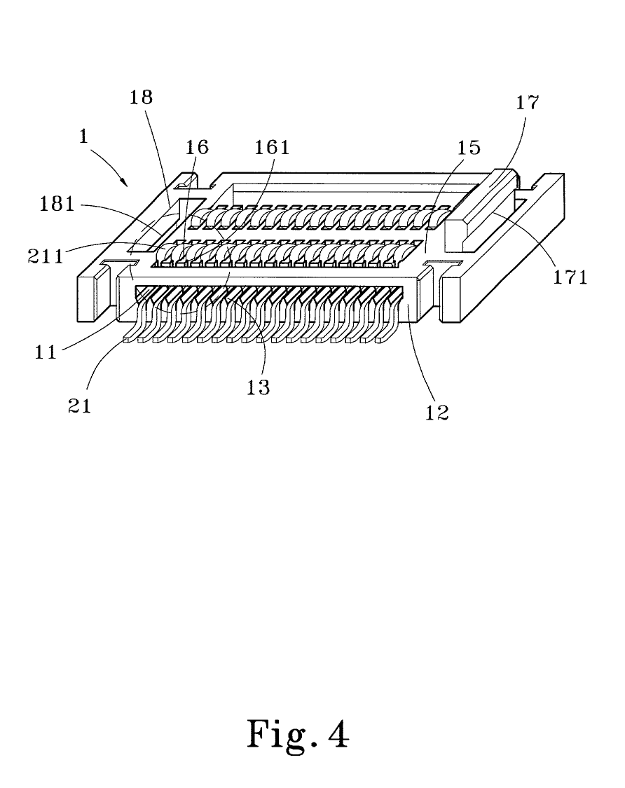

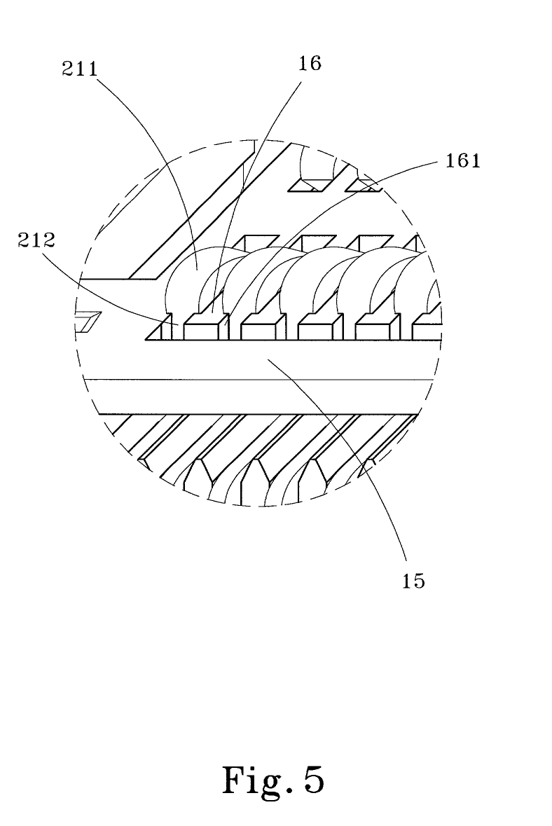

Referring to FIGS. 4 and 5 for assembling of the contact legs in the casing, two neighboring contact legs 21 are separated by the first separators 13 of the casing 1. The tail ends of the contact legs 21 also are separated by the second separators 16 on the contact end surface 15. The bulged clip sections 161 of the second separators 16 are wedged into the slots 213 of the snap sections 212. Hence the contact surfaces 211 of the contact legs 21 will be anchored securely without moving away. The contact surfaces 211 thus are positioned for front face contact.

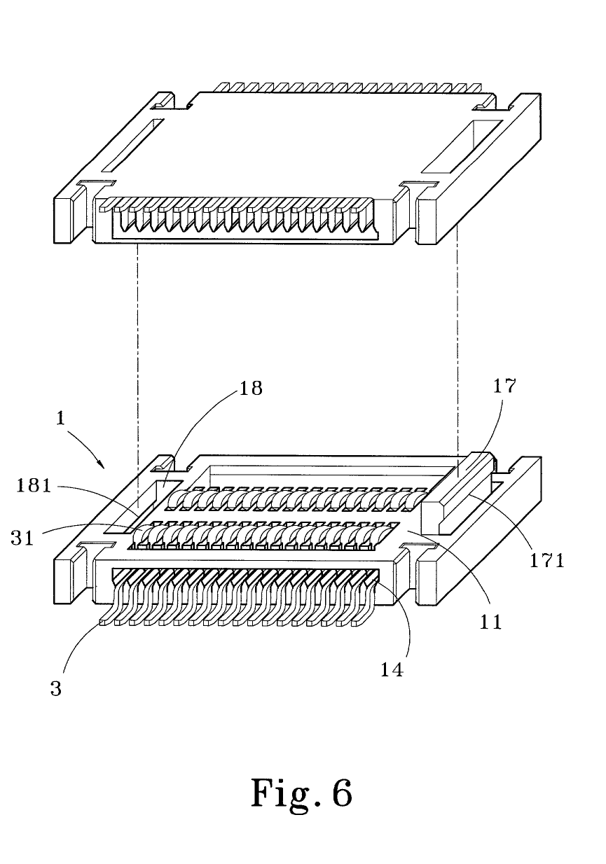

Referring to FIG. 6, when coupling two casings 1 embedded with the contact legs 21 to form a connector, engage the latch hook 17 of one casing 1 with the latch groove 18 of another casing 1 in only once direction. The contact surfaces 211 of the contact legs 21 of the two casings will face one another to form a front face contact thereby to achieve a secure and stable connection for improved signal transmission. And the contact surfaces 211 of the contact legs 21 do not incur wearing or peeling of the plated layer.

The connector assembly of the invention provides a front face contact between the contact surfaces of the matching contact legs when the contact end surfaces are coupled together. The contact legs thus will have more stable and secure contact to overcome the disadvantages existed in the conventional connectors.

What is claimed is:

1. A connector assembly, comprising:
a casing having a housing chamber which includes a plurality of leg troughs spaced by a plurality of separators, the separator having a bulged clip section formed on each of two lateral sides at one end thereof; and
a plurality of contact legs wedging in the leg troughs each having a contact surface for front face contact;
wherein two sets of the casing are coupled to form a connector with the contact surfaces of the matching contact legs in the connector facing each other to form a front face contact for the connector to achieve a stable and secure contact for signal transmission.

2. The connector assembly of claim 1 further having a latch hook extended upwards from the top end of the casing at a selected location of one side thereof and a latch groove formed at a selected location of another side of the top end, the latch hook having a latch lug formed on one side thereof, the latch groove having a stepwise latch notch formed therein.

3. The connector assembly of claim 1, wherein the casing is made of plastics by integral injection forming.

4. The connector assembly of claim 2, wherein the latch hook is made separately.

5. The connector assembly of claim 1, wherein the contact legs are formed by directly punching a base plate, the contact legs being wedged in the leg troughs of the casing through the base plate and cut off from the base plate.

6. The connector assembly of claim 1, wherein the contact legs are formed in a continuous undulatory shape by directly punching a base plate.

7. The connector assembly of claim 1, wherein the contact leg has a snap section formed at a selected location.

8. The connector assembly of claim 1, wherein the clip sections are extended and bulged on two sides of the separator.

9. The connector assembly of claim 1, wherein the snap section has a slot to match and engage with the clip section for the contact leg to wedge securely in the leg trough.
